(19) United States
(12) Patent Application Publication
(10) Pub. No.: US 2023/0012651 A1
(43) Pub. Date: Jan. 19, 2023

(54) DEVELOPING DEVICE AND IMAGE FORMING APPARATUS INCLUDING THE SAME

(71) Applicant: KYOCERA Document Solutions Inc., Osaka (JP)

(72) Inventor: Yu SASAKI, Osaka (JP)

(73) Assignee: KYOCERA Document Solutions Inc., Osaka (JP)

(21) Appl. No.: 17/858,366

(22) Filed: Jul. 6, 2022

(30) Foreign Application Priority Data
Jul. 14, 2021 (JP) 2021-116252

(51) Int. Cl. G03G 15/08

(52) U.S. Cl. CPC G03G 15/0891

(57) ABSTRACT

A developing device includes a developing container, a first stirring conveyance member, a second stirring conveyance member, and a developer carrying member. The developing container includes a first conveyance chamber and a second conveyance chamber that are arranged mutually side by side, and contains a two-component developer including a carrier and a toner. The first stirring conveyance member stirs and conveys the developer present in the first conveyance chamber in a first direction. The second stirring conveyance member stirs and conveys the developer present in the second conveyance chamber in a second direction. The developing container includes a toner replenishment portion that directly feeds a replenishment toner into the developer present in the first conveyance chamber from an upstream side of the first conveyance chamber with respect to the first direction. The carrier satisfies 0.73≤FR×AD/shape factor≤2.10.

### INCORPORATION BY REFERENCE

This application is based upon and claims the benefit of priority from the corresponding Japanese Patent Application No. 2021-116252 filed on Jul. 14, 2021, the entire contents of which are incorporated herein by reference.

### BACKGROUND

The present disclosure relates to a developing device that is used in an image forming apparatus using an electrophotographic method, such as a copy machine, a printer, a facsimile, or a multi-functional peripheral having functions thereof and the image forming apparatus including the same. The present disclosure relates particularly to a developing device that employs a two-component development method using a two-component developer including a toner and a carrier.

In an image forming apparatus, an electrostatic latent image formed on an image carrying member such as a photosensitive drum is developed by a developing device into a visible toner image. One type of such a developing device employs the two-component development method using a two-component developer. In a developing device of this type, a two-component developer (hereinafter, simply referred to also as a developer) composed of a carrier and a toner is contained in a developing container, and there are disposed a developing roller (a developer carrying member) that supplies the developer to the image carrying member and a stirring conveyance member that supplies the developer in the developing container to the developing roller while stirring and conveying the developer.

As the developing device employing the two-component development method, a developing device has been proposed in which a toner replenishment portion is provided on a side on which supply of a developer to the developing roller is not performed. According to this configuration, a replenished toner reaches the developing roller after being sufficiently stirred and mixed with the developer in the developing container, and thus it is possible to suppress the occurrence of fogging or carrier development due to an insufficient toner charge amount.

Meanwhile, a toner in a two-component developer contained in the developing container is consumed only in an amount required for development and thus may be retained in the developing container fir a long period of time. This has led to a fear that, when blocking, i.e., a state where the toner coagulates and becomes solidified, occurs in the developing container, the toner cannot be sufficiently supplied to an electrostatic latent image by use of the developing roller, resulting in causing image degradation.

### SUMMARY

A developing device according to one aspect of the present disclosure includes a developing container, a first stirring conveyance member, a second stirring conveyance member, and a developer carrying member. The developing container includes a plurality of conveyance chambers including a first conveyance chamber and a second conveyance chamber that are arranged mutually side by side, a partition wall that divides the first conveyance chamber and the second conveyance chamber from each other along a longitudinal direction, and a communication portion that establishes communication between the first conveyance chamber and the second conveyance chamber on both end sides of the partition wall, and contains a two-component developer including a carrier and a toner. The first stirring conveyance member stirs and conveys the developer present in the first conveyance chamber in a first direction. The second stirring conveyance member stirs and conveys the developer present in the second conveyance chamber in a second direction opposite to the first direction. The developer carrying member is rotatably supported to the developing container and carries, on a surface thereof, the developer present in the second conveyance chamber. The developing container includes a toner replenishment portion that directly feeds a replenishment toner into the developer present in the first conveyance chamber from an upstream side of the first conveyance chamber with respect to the first direction. The carrier satisfies Expression (1) below:

0.73≤FR×AD/shape factor≤2.10 (1)

where
FR denotes an amount of time [s/50 g] taken for 50 g of the carrier to be discharged,
AD denotes a bulk specific gravity [g/cm³] of the carrier, and
a shape factor refers to actually measured carrier volume average particle diameter/carrier particle diameter calculated from BET specific surface area.

### BRIEF DESCRIPTION OF THE DRAWINGS

FIG. 1 is a schematic sectional view of an image forming apparatus in which a developing device of the present disclosure is mounted.

FIG. 2 is a perspective view of a developing device according to one embodiment of the present disclosure.

FIG. 3 is a side sectional view of the developing device.

FIG. 4 is a plan sectional view showing a stirring portion of the developing device.

FIG. 5 is a side sectional view of a stirring conveyance chamber of the developing device.

FIG. 6 is a plan sectional view showing a stirring portion of a developing device (Comparative Examples 2 and 3) that causes a toner to fall down on an upstream side of a stirring conveyance portion in Example 2.

FIG. 7 is a graph showing a relationship between a combination of (FR×AD/shape factor) of a carrier and a toner replenishment method and toner charge rising characteristics.

### DETAILED DESCRIPTION

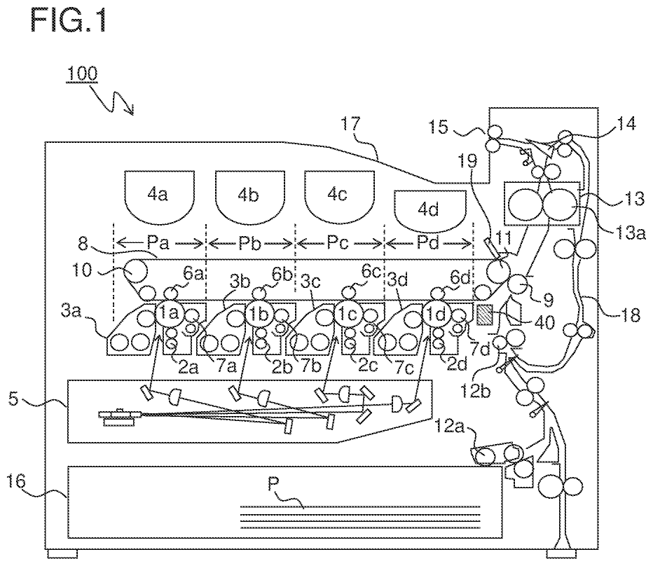

With reference to the appended drawings, the following describes an embodiment of the present disclosure. FIG. 1 is a sectional view showing an internal structure of an image forming apparatus 100 according to one embodiment of the present disclosure. In a main body of the image forming apparatus 100 (herein, a color printer), four image forming portions Pa, Pb, Pc, and Pd are sequentially disposed in order from an upstream side in a conveyance direction (a left side in FIG. 1). The image forming portions Pa to Pd are provided correspondingly to images of four different colors (yellow, cyan, magenta, and black), respectively, and sequentially form images of yellow, cyan, magenta, and black, respectively, by individually performing steps of charging, exposure, development, and transfer.

In the image forming portions Pa to Pd, photosensitive drums (image carrying members) 1a, 1b, 1c, and 1d are disposed, respectively, to carry visible images (toner images) of the respective colors. Moreover, an intermediate transfer belt (an intermediate transfer member) 8 that is driven by a belt drive motor (not shown) to rotate in a counterclockwise direction in FIG. 1 is provided adjacently to the image forming portions Pa to Pd. Toner images formed respectively on the photosensitive drums 1a to 1d are sequentially and primarily transferred in a superimposed manner on the intermediate transfer belt 8 moving while abutting on the photosensitive drums 1a to 1d. After that, the toner images thus primarily transferred on the intermediate transfer belt 8 are secondarily transferred by a secondary transfer roller 9 on a transfer sheet P as an example of a recording medium. Moreover, the toner images secondarily transferred to the transfer sheet P are fixed thereon in a fixing portion 13, and then the transfer sheet P is discharged from the main body of the image forming apparatus 100. An image forming process with respect to the photosensitive drums 1a to 1d is executed while the photosensitive drums 1a to 1d are rotated in a clockwise direction in FIG. 1.

The transfer sheet P on which toner images are to be secondarily transferred is housed in a sheet cassette 16 arranged in a lower part of the main body of the image forming apparatus 100. The transfer sheet P is conveyed to a nip between the secondary transfer roller 9 and a driving roller 11 of the intermediate transfer belt 8 via a paper feed roller 12a and a registration roller pair 12b. As the intermediate transfer belt 8, a seam-free (seamless) belt formed of a dielectric resin sheet is mainly used. Furthermore, a blade-shaped belt cleaner 19 for removing a residual toner or the like remaining on a surface of the intermediate transfer belt 8 is arranged on a downstream side of the secondary transfer roller 9.

Next, a description is given of the image forming portions Pa to Pd. Charging devices 2a, 2b, 2c, and 2d that charge the photosensitive drums 1a to 1d, respectively, an exposure device 5 that performs exposure based on image information with respect to the photosensitive drums 1a to 1d, developing devices 3a, 3b, 3c, and 3d that form toner images on the photosensitive drums 1a to 1d, respectively, and cleaning devices 7a, 7b, 7c, and 7d that remove a residual developer (toner) or the like remaining on the photosensitive drums 1a to 1d, respectively, are provided around and below the photosensitive drums 1a to 1d rotatably disposed.

Upon image data being inputted from a host apparatus such as a personal computer, first, surfaces of the photosensitive drums 1a to 1d are uniformly charged by the charging devices 2a to 2d, respectively. Then, by the exposure device 5, light is applied thereto so as to correspond to image data so that electrostatic latent images corresponding to the image data are formed on the photosensitive drums 1a to 1d, respectively. The developing devices 3a to 3d are filled with prescribed amounts of two-component developers including toners of yellow, cyan, magenta, and black, respectively. In a case where a percentage of the toners in the two-component developers filled in the developing devices 3a to 3d falls below a preset value due to after-mentioned toner image formation, the developing devices 3a to 3d are replenished with fresh supplies of toners from toner containers 4a to 4d, respectively. The toners in the developers are supplied onto the photosensitive drums 1a to 1d by the developing devices 3a to 3d, respectively, and electrostatically adheres thereto. Thus, there are formed toner images corresponding to the electrostatic latent images formed by exposure from the exposure device 5.

Further, by primary transfer rollers 6a to 6d, an electric field is applied at a prescribed transfer voltage between themselves and the photosensitive drums 1a to 1d, respectively. Thus, the toner images of yellow, magenta, cyan, and black on the photosensitive drums 1a to 1d are primarily transferred on the intermediate transfer belt 8. These images are formed in a prescribed positional relationship. After that, a residual toner or the like remaining on the surfaces of the photosensitive drums 1a to 1d after primary transfer is removed by the cleaning devices 7a to 7d, respectively, in preparation for subsequent formation of new electrostatic latent images.

The intermediate transfer belt 8 is stretched over a driven roller 10 on an upstream side and the driving roller 11 on a downstream side. As the driving roller 11 is driven to rotate by the belt drive motor (not shown), the intermediate transfer belt 8 starts to rotate in the counterclockwise direction, and then the transfer sheet P is conveyed at prescribed timing from the registration roller pair 12b to the nip (a secondary transfer nip) between the driving roller 11 and the secondary transfer roller 9 provided adjacently thereto. Further, the toner images on the intermediate transfer belt 8 are secondarily transferred on the transfer sheet P passing through the nip. The transfer sheet P on which the toner images have been secondarily transferred is conveyed to the fixing portion 13.

The transfer sheet P conveyed to the fixing portion 13 is heated and pressed by a fixing roller pair 13a, and thus the toner images are fixed on a surface of the transfer sheet P to form a prescribed full-color image thereon. A conveyance direction of the transfer sheet P on which the full-color image has been formed is controlled by a branch portion 14 branching off in a plurality of directions, and the transfer sheet P is directly (or after being conveyed to a double-sided conveyance path 18 and subjected to double-sided image formation therein) discharged to a discharge tray 17 by a discharge roller pair 15.

Moreover, an image density sensor 40 is arranged on a downstream side of the image forming portion 1d at a position opposed to the intermediate transfer belt 8. As the image density sensor 40, an optical sensor is used that includes a light-emitting element formed generally of an LED or the like and a light-receiving element formed of a photodiode or the like. In measuring an amount of a toner adhering on the intermediate transfer belt 8, measurement light is applied from the light-emitting element to reference images formed on the intermediate transfer belt 8 and then enters the light-receiving element as light reflected by the toner and light reflected by the surface of the intermediate transfer belt 8.

The light reflected from the toner and the light reflected from the surface of the intermediate transfer belt 8 include a specular reflection light component and a diffused reflection light component. The specular reflection light component and the diffused reflection light component are split with a polarization splitting prism and then enter separate light-receiving elements, respectively. Each of the light-receiving elements performs photoelectric conversion of a received one of the specular reflection light component and the diffused reflection light component and outputs an output signal to a control portion (not shown). Further, from a characteristic change in the output signal based on the received one of the specular reflection light component and the diffused reflection light component, a toner amount is detected and compared with a predetermined reference density so as to be used to adjust a characteristic value of a developing voltage or the like. In this manner, density correction (calibration) is performed.

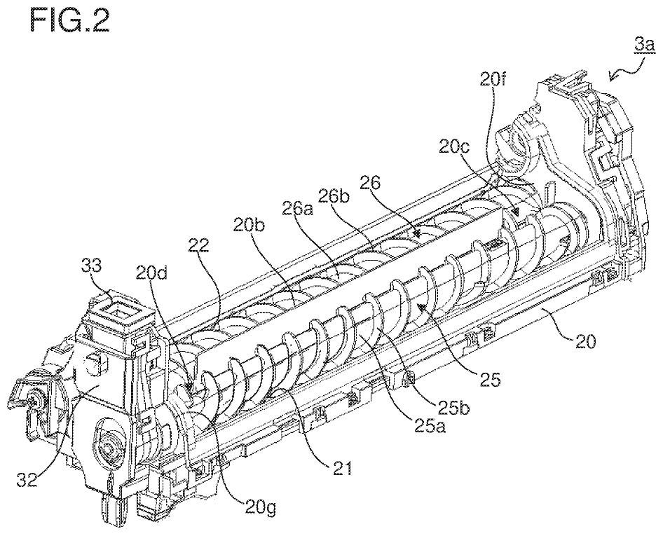

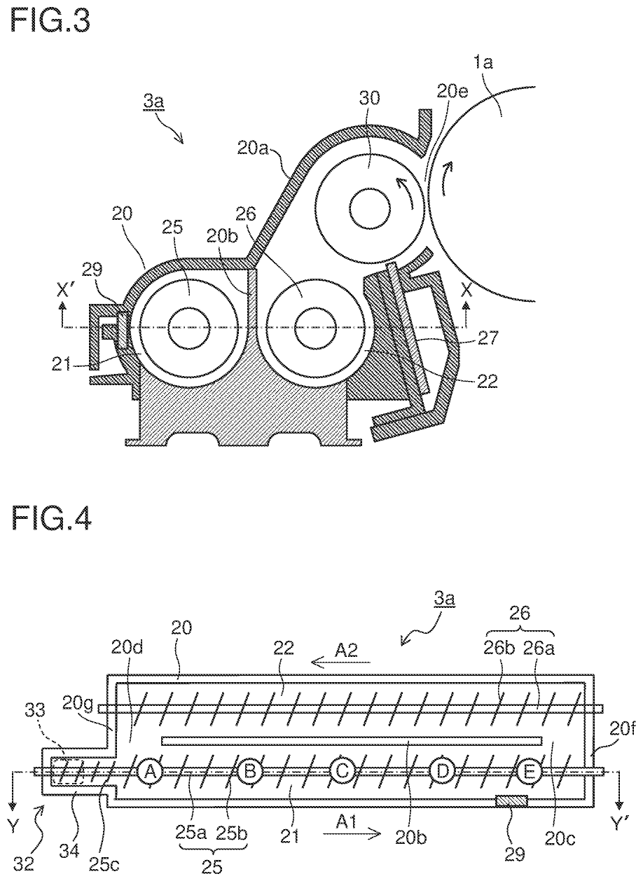

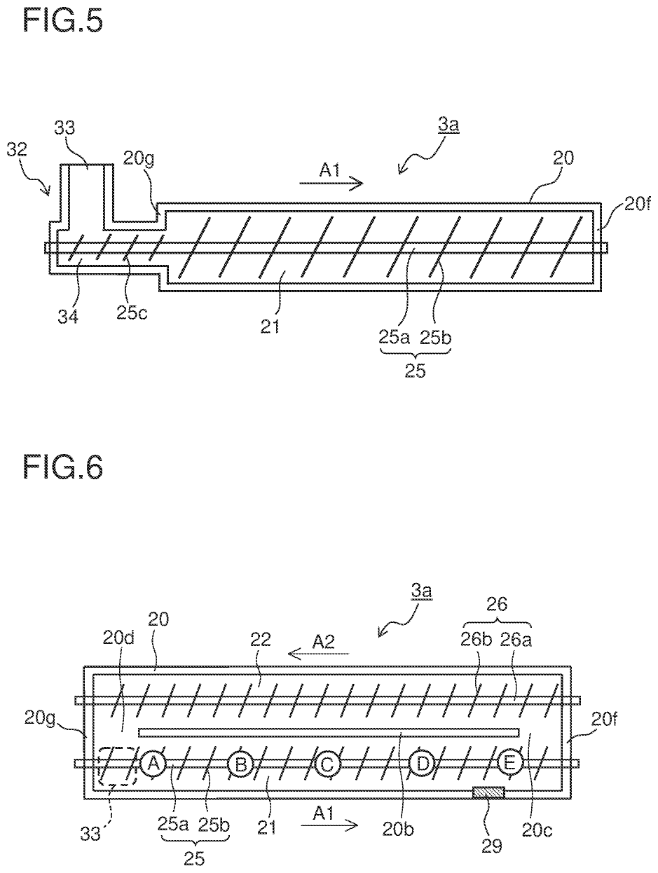

Next, a description is given of a configuration of the developing devices 3a to 3d. FIG. 2 is a perspective view of the developing device 3a according to one embodiment of the present disclosure mounted in the image forming apparatus 100. FIG. 3 is a side sectional view of the developing device 3a. FIG. 4 is a plan sectional view (a sectional view taken in a direction of arrows XX′ in FIG. 3) showing a stirring portion of the developing device 3a. FIG. 5 is a side sectional view (a sectional view taken in a direction of arrows YY′ in FIG. 4) of a stirring conveyance chamber 21 of the developing device 3a. FIG. 2 shows a state where a cover member 20a of a developing container 20 and a developing roller 30 have been removed. Furthermore, while the following describes, as an example, the developing device 3a arranged in the image forming portion Pa shown in FIG. 1, the developing devices 3b to 3d arranged in the image forming portions Pb to Pd, respectively, also have a basically similar configuration thereto, and thus descriptions thereof are omitted.

As shown in FIG. 2 and FIG. 3, the developing device 3a includes the developing container 20 for containing a two-component developer (hereinafter, simply referred to also as a developer) including a magnetic carrier and a toner. The developing container 20 includes the cover member 20a, a partition wall 20b, a first communication portion 20c, a second communication portion 20d, a stirring conveyance chamber 21 (a first conveyance chamber), a supply conveyance chamber 22 (a second conveyance chamber), and a toner replenishment portion 32.

The cover member 20a is attachable/detachable with respect to a main body of the developing container 20 and constitutes an upper part of the developing container 20. The partition wall 20b divides an interior of the developing container 20 into the stirring conveyance chamber 21 and the supply conveyance chamber 22 that are arranged side by side. At both ends of the partition wall 20b in a longitudinal direction thereof, the first communication portion 20c and the second communication portion 20d establish communication between the stirring conveyance chamber 21 and the supply conveyance chamber 22.

In the stirring conveyance chamber 21 and the supply conveyance chamber 22, a stiffing conveyance screw 25 (a first stiffing conveyance member) and a supply conveyance screw 26 (a second stirring conveyance member) for making a mixture of a toner supplied from the toner container 4a (see FIG. 1) and a magnetic carrier, stirring the mixture, and charging the toner are rotatably disposed, respectively. This embodiment uses a two-component developer composed of a positively chargeable toner and a ferrite/resin-coated carrier. Detailed configurations of the toner and the carrier will be described later.

The stirring conveyance screw 25 includes a rotary shaft 25a, and a first conveyance vane 25b that is helically formed at a set pitch on the rotary shaft 25a in an axis direction thereof. The rotary shaft 25a and the first conveyance vane 25b are integrally formed using a synthetic resin. The first conveyance vane 25b extends to both end sides of the stirring conveyance chamber 21 in a longitudinal direction thereof so as also to be opposed to the first communication portion 20c and the second communication portion 20d. The rotary shaft 25a is rotatably supported to a first side wall 20f and a second side wall 20g of the developing container 20. The stirring conveyance screw 25 conveys, while stirring, a developer present in the stirring conveyance chamber 21 in a set direction (a first direction, an arrow A1 direction).

The supply conveyance screw 26 includes a rotary shaft 26a and a second conveyance vane 26b that is helically formed at a set pitch on the rotary shaft 26a in an axis direction thereof. The rotary shaft 26a and the second conveyance vane 26b are integrally formed using a synthetic resin. The second conveyance vane 26b has a length not less than a length of the developing roller 30 in an axis direction thereof and further extends to a position opposed to the first communication portion 20c. The rotary shaft 26a is arranged parallel to the rotary shaft 25a and is rotatably supported to the first side wall 20f and the second side wall 20g of the developing container 20. The supply conveyance screw 26 conveys, while stirring, the developer present in the supply conveyance chamber 22 in a direction (a second direction, an arrow A2 direction) opposite to the conveyance direction of the stirring conveyance screw 25.

Further, the developer is conveyed while being stirred by the stirring conveyance screw 25 and the supply conveyance screw 26 in an axis direction thereof (a direction perpendicular to a plane on which FIG. 3 is drawn) and circulates between the stirring conveyance chamber 21 and the supply conveyance chamber 22 via the first communication portion 20c and the second communication portion 20d formed at the both ends of the partition wall 20b. That is, in the developing container 20, a circulation route of the developer is formed by the stirring conveyance chamber 21, the first communication portion 20c, the supply conveyance chamber 22, and the second communication portion 20d.

The developing container 20 extends to a diagonally upper right side in FIG. 3, and the developing roller 30 (a developer carrying member) is arranged on a diagonally upper right side of the supply conveyance screw 26 in the developing container 20. Further, a part of an outer circumferential surface of the developing roller 30 is exposed through an opening 20e of the developing container 20 and is opposed at a prescribed distance (a developing gap) to the photosensitive drum 1a. The developing roller 30 rotates (performs trail rotation at a position opposed to the photosensitive drum 1a) in a counterclockwise direction in FIG. 3.

The developing roller 30 is composed of a cylindrical developing sleeve that rotates in the counterclockwise direction in FIG. 3 and a magnet (not shown) that has a plurality of magnetic poles and is secured in the developing sleeve. While the developing sleeve used herein is a developing sleeve having a knurled surface, it is also possible to use a developing sleeve having a surface with a multitude of concaves (dimples) formed therein, a developing sleeve having a blasted surface, a developing sleeve having a surface not only knurled and including concaves formed therein but also blasted, a developing sleeve having a plated surface intended to improve endurance, a developing sleeve having an anodized surface, or a developing sleeve having a surface treated, after being anodized, by a method in which a metallic salt such as Ni, Sn, or Mo is applied to a porous region of anodized aluminum, i.e., a so-called secondary electrolytic coloring method.

Particularly when having an anodized surface or a surface treated, after being anodized, by the secondary electrolytic coloring method, a developing sleeve has not only improved endurance but also an effect of suppressing the occurrence of a development leak. This is because, with the surface of the developing sleeve anodized, a leakage current generated at a magnetic brush becomes unlikely to spread in a circumferential direction on a surface of the developing roller 30 and thus is prevented from developing into a larger-scale leakage current involving adjacent magnetic brushes. By a developing voltage power source (not shown), a developing voltage composed of a direct current voltage Vdc and an alternating current voltage Vac is applied to the developing roller 30.

Furthermore, a restriction blade 27 is attached to the developing container 20 along a longitudinal direction of the developing roller 30 (a perpendicular direction to the plane on which FIG. 3 is drawn). A slight clearance (gap) is formed between a distal end of the restriction blade 27 and the developing roller 30. In this embodiment, a magnetic blade made of stainless steel (SUS430) is used as the restriction blade 27.

On a side surface of the stirring conveyance chamber 21, a toner concentration sensor 29 is arranged to be opposed to the stirring conveyance screw 25. The toner concentration sensor 29 detects a concentration of a toner in a developer (a mixing ratio T/C of the toner to a carrier in the developer) in the developing container 20. As the toner concentration sensor 29, for example, a magnetic permeability sensor is used that detects a magnetic permeability of a two-component developer composed of a toner and a magnetic carrier in the developing container 20. Based on a toner concentration detected by the toner concentration sensor 29, a toner in the toner container 4a (see FIG. 1) is replenished into the developing container 20 via the toner replenishment portion 32.

The toner replenishment portion 32 is provided on an upstream side with respect to a developer conveyance direction in the stirring conveyance chamber 21. The toner replenishment portion 32 includes a toner replenishment port 33 and a toner replenishment path 34. The toner replenishment port 33 is open at an upper part of the toner replenishment portion 32 and is connected to the toner container 4a (see FIG. 1). The toner replenishment path 34 extends horizontally on a lower side of the toner replenishment port 33 and communicates with the stirring conveyance chamber 21 from the upstream side (a left side in FIG. 4 and FIG. 5) with respect to the developer conveyance direction (the arrow A1 direction) in the stirring conveyance chamber 21.

The rotary shaft 25a of the stirring conveyance screw 25 passes through the second side wall 20g of the developing container 20 and extends into the toner replenishment path 34. A replenishment vane 25c that is helically formed at a set pitch on the rotary shaft 25a in the axis direction thereof is integrally formed with a part of the rotary shaft 25a arranged in the toner replenishment path 34. The replenishment vane 25c is formed of a vane helically wound in the same direction (in the same phase) as a winding direction of the first conveyance vane 25b so as to be smaller in pitch and diameter than the first conveyance vane 25b. That is, the stirring conveyance screw 25 functions also as a conveyance member that conveys a toner in the toner replenishment path 34 toward the stirring conveyance chamber 21.

A replenishment toner conveyed from the toner container 4a (see FIG. 1) into the toner replenishment portion 32 via the toner replenishment port 33 falls down in the toner replenishment path 34. The replenishment toner that has fallen down in the toner replenishment path 34 is conveyed in a horizontal direction (a rightward direction in FIG. 4 and FIG. 5) by the replenishment vane 25c of the stirring conveyance screw 25 and enters the stirring conveyance chamber 21 along the rotary shaft 25a. Further, the replenishment toner is stirred and mixed with a developer (a developer passing through the second communication portion 20d to circulate from the supply conveyance chamber 22) present in the stirring conveyance chamber 21 and thus is charged to a prescribed charge amount.

In a replenishment method in which a toner is caused to fall down from immediately above on a developer circulating in the developing container 20 as described earlier, due to a difference in specific gravity between the toner and a carrier, it takes time for the toner to sink from above to below the developer. Because of this, a replenishment toner is unlikely to be mixed into the developer in the developing device 3a and thus might reach the developing roller 30 before a toner charge amount increases to a desired value, resulting in causing image fogging.

For example, in a case where the occurrence of carrier development cannot be suppressed in the image forming apparatus 100 with an increased printing velocity (process linear velocity), it is required that a development potential difference between a development potential and a surface potential of each of the photosensitive drums 1a to 1d be set to be low. Meanwhile, a decrease in the development potential difference makes image fogging likely to occur. Here, an increase in linear velocity also makes an occurrence level of image fogging likely to be worsened, rendering it even more difficult to perform designing.

This embodiment has a configuration in which, with respect to a developer circulating in the developing container 20, a toner is directly replenished from an upstream side of the stirring conveyance chamber 21 into the developer present in the stirring conveyance chamber 21 along the rotary shaft 25a of the stirring conveyance screw 25. Thus, the replenishment toner is swiftly taken and mixed into the developer, and thus toner charge rising characteristics can he improved.

Particularly in a case where a toner replenishment method of this embodiment is employed in the image forming apparatus 100 with an increased printing velocity (process linear velocity), a toner charge amount swiftly rises, and thus it is possible to suppress image fogging and also to set the toner charge amount to be somewhat higher. That is, with an increased printing velocity (process linear velocity), an effect of the developing devices 3a to 3d of this embodiment is remarkably exhibited.

However, even when the developing devices 3a to 3d of this embodiment are used, there may be a case where a replenishment toner fed from the toner replenishment path 34 into the stirring conveyance chamber 21 is pushed back at a merging point (in a vicinity of the second communication portion 20d) where the replenishment toner merges with a developer circulating in the developing container 20, and thus it takes time for the replenishment toner to be fed in a required amount. Specifically, in a case where the developer circulating in the developing container 20 has poor fluidity, the replenishment toner becomes unlikely to be taken in. In order, therefore, to make the replenishment toner likely to be taken in, it is required to use a developer having high fluidity.

Next, a description is given of a two-component developer used in the developing devices 3a to 3d of the present disclosure. The two-component developer includes a toner and a carrier. A toner concentration (a weight ratio of the toner to the carrier, T/C) in the two-component developer is preferably 5 to 20 parts by mass with respect to 100 parts by mass of the carrier.

### [Toner]

For example, a positively chargeable toner can be used as the toner. The positively chargeable toner becomes positively (plus) charged by friction with the carrier. Toner particles each include a toner base particle and an external additive that adheres to a surface of the toner base particle as required. There is no particular limitation on a configuration of the toner base particle. The external additive does not need to be added when not required. In a case of not adding the external additive, the toner base particle corresponds to each of the toner particles.

The toner base particle contains a binder resin and a colorant. In the toner base particle, a mold release agent, an electric charge control agent, a magnetic powder, and so on may be contained as required. The toner base particle has a weight average particle diameter of preferably 5 to 12 μm and more preferably 6 to 10 μm. The weight average particle diameter of the toner base particle is measured using a particle size distribution measurement device (for example, Multisizer II produced by Beckman Coulter, Inc.). The toner base particle is produced by a known method such as a pulverization classification method, a melt granulation method, a spray granulation method, or a polymerization method.

In a case of adding the external additive, in order to obtain a toner having excellent fluidity, preferably, inorganic particles having a number-average primary particle diameter of not less than 5 nm and not more than 30 nm are used as the external additive. In order to obtain a toner having excellent heat-resistant storage stability by making the external additive function as a spacer between toner particles, preferably, resin particles having a number-average primary particle diameter of not less than 50 nm and not more than 200 nm are used as external additive particles. Examples of the external additive include inorganic oxides such as silica, a titanium oxide, and alumina and metallic soaps such as calcium stearate. In order to make the external additive sufficiently exert its functions while suppressing falling-off of the external additive from the toner base particle, preferably, the external additive is added in an amount of not less than 1 part by mass and not more than 10 parts by mass with respect to 100 parts by mass of the toner base particle.

The toner particles may be toner particles each not having a shell layer (non-capsule toner particles) or toner particles each having the shell layer (capsule toner particles). The capsule toner particles each include a toner base particle having a toner core and the shell layer that covers a surface of the toner core. There is no particular limitation on a configuration of the toner core. The shell layer may he substantially made only of a thermosetting resin, may be substantially made only of a thermoplastic resin, or may contain both of the thermoplastic resin and the thermosetting resin. In order to obtain a toner suitable for image formation, preferably, the toner base particle has a volume average particle diameter (D50) of not less than 4 μm and not more than 9 μm.

Moreover, in each of the toner particles, a hydrophobic silica particle and a styrene-acrylate resin fine particle are made to adhere to the toner base particle. The hydrophobic silica particle acts as a charge adjustment agent that adjusts a toner charge amount. The styrene-acrylate resin fine particle acts as a spacer for preventing the silica particle from being embedded in the toner base particle. While typically adhering to a surface of the carrier during endurance to cause a decrease in charging performance of the carrier, the styrene-acrylate resin fine particle has weak adhesion to a silicone resin coat layer containing an after-mentioned ferroelectric particle and thus is prevented from continuously and increasingly accumulating on the carrier. While a detailed principle is unknown, presumably, this is because the styrene-acrylate resin fine particle has little adhesion to a ferroelectric substance exposed on a surface of the coat layer and thus is likely to be peeled off therefrom.

### [Carrier]

The carrier used in the present disclosure includes a carrier core that is a particle of a magnetic substance and the coat layer that is made of a silicone resin or the like and is formed on a surface of the carrier core. A silicone-based resin can he applied to form a thin coat film, thus enhancing uniformity of the coat layer. Furthermore, the smaller a thickness of the coat layer, the higher a capacitance of the coat layer, and thus an effect of the ferroelectric substance added to the coat layer becomes likely to be exerted. When the carrier is assumed to be truly spherical, preferably, the coat layer has an average weight per unit area (an average film weight) of 0.2 to 2.7 [g/m²].

The carrier can be of a varying shape from indefinite to spherical. Moreover, as the carrier, a carrier having an average particle diameter (a number-average particle diameter) of not less than 20 μm and not more than 65 μm can be used. When having an average particle diameter of not more than 65 μm, the carrier is increased in specific surface area and thus can carry an increased amount of the toner. Thus, a toner concentration in a magnetic brush can be maintained high, and the toner is therefore sufficiently supplied to the developing roller 30, so that a toner layer having a sufficient thickness can be formed. As a result, it is possible to cause a sufficient amount of the toner to fly from the toner layer to an electrostatic latent image on a photosensitive member, to suppress a decrease in image density, and to suppress unevenness in the image density. Furthermore, since the toner is sufficiently supplied to the developing roller 30, it becomes unlikely that a toner dropout region is formed in the toner layer of the developing roller 30, thus suppressing the occurrence of a hysteresis.

When the carrier has an average particle diameter smaller than 20 μm, there occurs carrier development in which the carrier adheres to the photosensitive drums 1a to 1d. The carrier that has adhered thereto might shift to the intermediate transfer belt 8 to cause a transfer void or move to the belt cleaner 19 to cause a cleaning failure. Furthermore, when the carrier has an average particle diameter larger than 65 μm, with the toner in the two-component developer moving from the developing roller 30 to any of the photosensitive drums 1a to 1d, a coarse magnetic brush of the two-component developer is formed to degrade image quality.

Examples of a material of the carrier core include magnetic metals such as iron, nickel, and cobalt, alloys thereof, alloys containing rare earths, soft ferrites such as hematite, magnetite, manganese-zinc-based ferrite, nickel-zinc-based ferrite, manganese-magnesium-based ferrite, and lithium-based ferrite, iron-based oxides such as copper-zinc-based ferrite, and mixtures thereof. The carrier core is produced by a known method such as sintering or atomization. Among carriers made of the above-described materials, ferrite carriers have excellent fluidity and are also chemically stable and thus are favorably used from viewpoints of enhancing image quality and prolonging service life. When a magnetic field of 3000 Oe is applied to the carrier core, preferably, the carrier core has a saturation magnetization of not less than 65 emu/g and not more than 45 emu/g and a coercive force Hc of not less than 12 Oe and not more than 60 Oe.

As the ferroelectric substance, barium titanate particles are added to the coat layer. While hydrothermal polymerization, an oxalate method, or the like is used to produce barium titanate, barium titanate has physical properties varying depending on a production method thereof. When produced by the hydrothermal polymerization in particular, barium titanate has hollows therein and thus has a small absolute specific gravity and a sharp particle diameter distribution. As a result, compared with a case of being produced by any other production method, barium titanate produced by the hydrothermal polymerization has excellent dispersibility in a coat resin and thus can be dispersed uniformly. Accordingly, the charging performance of the carrier is also made uniform, and thus the hydrothermal polymerization is suitably used in the present disclosure.

Preferably, barium titanate has a volume average particle diameter of not less than 100 nm and not more than 500 nm. When having a particle diameter smaller than 100 nm, barium titanate is abruptly decreased in relative dielectric constant, so that an effect thereof related to the relative dielectric constant is reduced. On the other hand, when having a particle diameter of not less than 500 nm, barium titanate can hardly be uniformly dispersed in the coat layer.

When barium titanate is added in an amount of not less than 5 parts by mass with respect to a coat weight, an effect of stabilizing a charge amount starts to manifest itself, and when barium titanate is added in an amount of not less than 25 parts by mass with respect thereto, the effect of stabilizing a charge amount is more remarkably exhibited. When added in an excessively large amount, however, barium titanate can no longer be completely contained in the coat layer and might be partly liberated from the coat layer. A liberated part of the barium titanate might move to the photosensitive drums 1a to 1d and further into an edge part of a cleaning blade of each of the cleaning devices 7a to 7d, resulting in causing a cleaning failure. For this reason, with respect to 100 parts by mass of the coat resin, barium titanate is added in an amount of preferably not less than 5 parts by mass and not more than 45 parts by mass and more preferably not less than 25 parts by mass and not more than 45 parts by mass.

As an electric conductor, carbon black is added to the coat layer. When the carbon black is added in an excessively large amount, a part of the carbon black liberated from the coat layer might adhere to the toner, causing color turbidity of toners of colors other than black. On the other hand, when the carbon black is added in an excessively small amount, it is unlikely that electric charge moves from the carrier to the toner, resulting in a failure to cause a smooth increase in toner charge amount. In the carrier of the present disclosure, barium titanate (the ferroelectric substance) is added to the coat layer so that a carrier resistance is decreased, and thus an amount of carbon black to be added can be reduced by an amount corresponding to a decrease in the carrier resistance.

Adding the ferroelectric substance (barium titanate) to the coat layer enhances an electric charge retaining capability of the carrier, thus enabling sufficient electric charge to be applied to the toner. Furthermore, adding the electric conductor (carbon black) to the coat layer enables smooth movement of electric charge from the carrier to the toner. Even when a toner concentration is increased to increase the number of toner particles to be charged, synergy between the above-described two additives enables electric charge to be applied to a saturation level of a charge amount of the toner particles.

This embodiment is designed to adjust respective amounts of the ferroelectric substance and the electric conductor to be added to the coat layer of the carrier and to adjust a particle diameter and a coat film thickness so as to satisfy Expression (1) below:

0.73≤FR×AD/shape factor≤2.10 (1).

In Expression (1), the shape factor is a factor representing a particle shape and is defined by Expression (2) below:

Shape factor=Actually measured carrier volume average particle diameter/Carrier particle diameter calculated from BET specific surface area (2)

where

Carrier particle diameter calculated from BET specific surface area=6/(BET specific surface area×absolute specific gravity).

When the shape factor is excessively large, it becomes likely that the shape factor varies due to, for example, the coat layer being abraded during endurance printing, resulting in poor endurance stability. On the other hand, when the shape factor is excessively small, toner chargeability is decreased. The shape factor, therefore, has an appropriate range.

The BET specific surface area is a specific surface area measured by a BET method (a nitrogen adsorption specific surface area method) and is specifically determined from an amount of liquid nitrogen absorbed on a surface of the carrier. More specifically, for example, by use of an automatic specific surface area measurement device (Macsorb Model 1208 produced by Mountech Co., Ltd.), nitrogen is absorbed on a surface of a specimen, and a BET specific surface area [m²/g] of the specimen can be measured by a flow method (a BET one-point method).

In Expression (1), FR×AD is an index indicating fluidity of the carrier. When the fluidity of the carrier is excessively high, mixability with the toner is decreased to decrease the toner chargeability. On the other hand, when the fluidity of the carrier is excessively low, a conveyance speed of the developer in the developing container 20 is decreased to cause a decrease in image density in continuous image printing at a high coverage rate. The fluidity of the carrier, therefore, has an appropriate range.

FR denotes a degree of fluidity of the carrier that is a value [s/50 g] indicating an amount of time taken for 50 g of the carrier to be discharged. Since a discharge amount of the carrier more closely matches an actual behavior when considered in terms of volume rather than weight, in this embodiment, FR×AD obtained by correcting FR with a bulk specific gravity AD [g/cm³] of the carrier is used as the index of fluidity of the carrier.

FR can be measured pursuant to the “JIS (Japanese Industrial Standards) Z2502.” To be specific, a metallic funnel (having a cone angle of 60°, an orifice diameter of 2.5 mm, and an orifice length of 3.2 mm) is prepared, and 50 g of a specimen (a carrier) is poured into the funnel with an orifice thereof closed. Subsequently, time measurement with a stopwatch is started concurrently with opening of the orifice of the funnel and is ended at an instant when a last remaining part of the carrier leaves the orifice. An amount of time thus measured (a pass-through time) corresponds to FR. AD can be measured pursuant to “Method for Testing Apparent Density of Metal Powders, JIS-Z2504.”

When the fluidity of the carrier is excessively high, mixability with the toner is decreased to cause a decrease in charging property (chargeability) with respect to the toner. On the other hand, when the fluidity of the carrier is excessively low, the conveyance speed of the developer in the developing container 20 is decreased to cause a decrease in image density in continuous image printing at a high coverage rate. Because of this, when (FR×AD/shape factor) gives a value smaller than 0.73, the fluidity becomes likely to vary during endurance printing. Furthermore, there occurs large variations in the chargeability, leading to the occurrence of image fogging. On the other hand, when (FR×AD/shape factor) gives a value larger than 2.10, it is likely that a decrease in image density of an outputted image having a high coverage rate and insufficient charging (a decrease in toner charge amount) occur, also leading to the occurrence of image fogging. That is, by satisfying Expression (1) above, it is possible to stabilize the chargeability of the carrier and thus to maintain, over a long period of time, a state where the occurrence of image fogging is reduced.

A developer including the above-described carrier is used in each of the developing devices 3a to 3d of this embodiment employing a method in which a toner is directly replenished into the developer present in the stirring conveyance chamber 21 along the rotary shaft 25a of the stirring conveyance screw 25, and thus it becomes unlikely that a replenishment toner fed from the toner replenishment path 34 into the stirring conveyance chamber 21 is pushed back at a merging point where the replenishment toner merges with the developer circulating in the developing container 20. As a result, the replenishment toner is swiftly taken into the developer in the developing container 20, and thus a toner charge amount can be promptly and stably raised to a desired value.

Other than the above, the present disclosure is not limited to the foregoing embodiment and can be variously modified without departing from the spirit of the present disclosure. For example, the present disclosure is not limited to the developing device including the developing roller 30 shown in FIG. 2 and is applicable to various types of developing devices using a two-component developer including a toner and a carrier. For example, the present disclosure is also applicable, exactly in a similar manner, to a developing device including a magnetic roller (a toner supply roller) carrying a developer on an outer circumferential surface thereof, in which only a toner in the developer carried on the magnetic roller is supplied to the developing roller 30 so that a toner layer is formed on the outer circumferential surface of the developing roller 30 and used to develop an electrostatic latent image on a photosensitive drum.

Furthermore, while the foregoing embodiment has a configuration in which the replenishment vane 25c is provided coaxially with the rotary shaft 25a of the stirring conveyance screw 25, and a toner is replenished along the rotary shaft 25a, there is no limitation thereto. Without being limited to the configuration in which replenishment is performed from a position coaxial with the rotary shaft 25a, the present disclosure may also be configured so that a toner is replenished from a position different from a position of the rotary shaft 25a as long as the toner is directly fed from an upstream side of the stirring conveyance chamber 21 into a developer in the developing container 20.

Furthermore, the present disclosure is applicable not only to a tandem color printer shown in FIG. 1 but also to various types of image forming apparatuses employing the two-component development method, such as a digital or analog monochrome copy machine, a monochrome printer, a color copy machine, and a facsimile. The following more specifically describes the effects of the present disclosure with reference to examples.

### EXAMPLE 1

### [Production of Carrier Containing Ferroelectric Particles]

### Production Example 1

By use of a homomixer, 500 g of a silicone resin (produced by Shin-Etsu Chemical Co., Ltd., KR-255), 150 g of barium titanate (produced by Sakai Chemical Industry Co., Ltd., a hydrothermal synthesis method), 10 g of carbon black (produced by Lion Corporation, Ketjenblack EC), and 1450 g of toluene were dispersed to provide a coat solution. The coat solution thus obtained was sprayed using a fluidized-bed coating device over 5 kg of a carrier core (an Mn ferrite carrier having a volume average particle diameter of 34.7 μm, a saturation magnetization of 70 emu/g, and a coercive force of 8 Oe and produced by Dowa IP Creation Co., Ltd.) under heating at 200° C. so that the carrier core was coated with the coat solution. After that, the carrier core was calcined for an hour at 250° C. using an electric furnace, was cooled down, and then was crushed and classified using a sieve to provide a carrier that includes a coat layer containing 30 parts by mass of ferroelectric particles (barium titanate) and has a volume average particle diameter (D50) of 52.3 μm.

The volume average particle diameter (D50) of barium titanate and the carrier core was measured using a laser diffraction/scattering-type particle size distribution measurement device (LA-950 produced by Horiba, Ltd.).

### EXAMPLE 2

[Evaluation of Toner Charge Amount Rising Characteristics Varying with Difference in Toner Replenishment Method and Type of Carrier]

A study was made on toner charge amount rising characteristics in a case where a method for replenishing a toner to the developing devices 3a to 3d and a type of a carrier in a developer were made to vary.

In a test method, there were prepared a developing device 3a (according to the present disclosure) employing the toner replenishment method shown in FIG. 4 and FIG. 5, in which a two-component developer including the carrier satisfying FR×AD/shape factor=1.13 and produced in Production Example 1 was filled, a developing device 3a (Comparative Example 1) employing the toner replenishment method shown in FIG. 4 and FIG. 5, in which a two-component developer including a carrier satisfying FR×AD/shape factor=0.68 was filled, a developing device 3a (Comparative Example 2) employing a toner replenishment method in which the toner replenishment port 33 was arranged on an upper side in a stirring conveyance chamber 21 shown in FIG. 6, and a replenishment toner was caused to fall down from immediately above on an upstream side of the stirring conveyance chamber 21, in which the two-component developer including the carrier satisfying FR×AD/shape factor=1.13 was filled, and a developing device 3a (Comparative Example 3) shown in FIG. 6, in which the two-component developer including. the carrier satisfying FR×AD/shape factor=0.68 was filled.

The above-described four different types of developing devices 3a were filled with 200 g of the respective developers. Further, the stirring conveyance screw 25 and the supply conveyance screw 26 of each of the developing devices 3a were driven at 350 [rpm] for a prescribed length of time in a room temperature and humidity environment (R/R environment at a temperature of 23° C. and a humidity of 50%), and a toner charge amount at positions (A to E) shown in FIG. 4 and FIG. 6 was measured. An amount of a toner to be replenished through the toner replenishment port 33 to the toner replenishment path 34 was set to 0.25 g per supply, and the replenishment vane 25c was rotated to cause a set amount of the toner to be replenished from the toner replenishment path 34 to the stirring conveyance chamber 21.

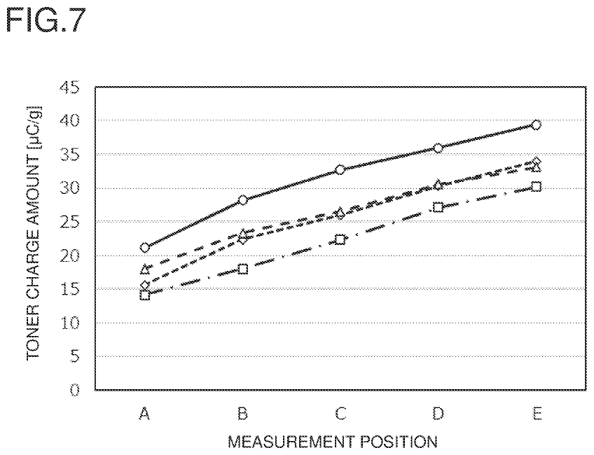

As the toner, a positively chargeable toner having an average particle diameter of 6.8 μm was used, and an initial toner concentration in the developers (a weight ratio of the toner to each of the carriers) was set to 6%. The developers used had been adjusted so that a saturation value of the toner charge amount under conditions of this experiment was 41 μC/g, and it can be said that the closer a value of the toner charge amount at the position E is to 41 μC/g, the closer the toner charge amount is to a theoretical value. FIG. 7 shows results of the measurement of the charge amount.

As shown in FIG. 7, in the present disclosure, (a solid line in FIG. 7) using a combination of the carrier satisfying FR×AD/shape factor=1.13 and the developing device 3a of this embodiment, a high charge amount was obtained at all of the positions A to D, and the charge amount rose as high as 40 μC/g at the position E. In contrast, in Comparative Example 1 (a broken line in FIG. 7) using a combination of the carrier satisfying FR×AD/shape factor=0.68 and the developing device 3a of this embodiment, there occurred a delay in replenishing the toner from the toner replenishment path 34 to the stirring conveyance chamber 21, so that a rise in the toner charge amount at each of the positions A to E was delayed compared with that in the present disclosure.

Furthermore, in Comparative Example 2 (a dotted line in FIG. 7) using a combination of the carrier satisfying FR×AD/shape factor=1.13 and the developing device 3a shown in FIG. 6, it took time for the replenishment toner that had fallen down from immediately above to be taken into the developer, so that a rise in the toner charge amount at each of the positions A to E was delayed to the same extent as that in Comparative Example 1. Moreover, in Comparative Example 3 (an alternate long and short dashed line in FIG. 7) using a combination of the carrier satisfying FR×AD/shape factor=0.68 and the developing device 3a shown in FIG. 6, due to low fluidity of the developer, a rise in the toner charge amount was delayed even more than that in Comparative Examples 1 and 2.

The foregoing results have confirmed that when a developer including a carrier satisfying 0.73≤FR×AD/shape factor≤2.10 is used in the developing device 3a employing the toner replenishment method shown in FIG. 4 and FIG. 5, a toner is smoothly fed from the toner replenishment path 34 into the stirring conveyance chamber 21, so that toner charge rising characteristics are improved, and thus it is possible to effectively suppress image fogging and carrier development.

The present disclosure is usable in a developing device that uses a two-component developer including a toner and a carrier. Through the use of the present disclosure, it is possible to provide a developing device capable of improving toner charge rising characteristics in the two-component development method and suppressing the occurrence of image fogging and carrier development and an image forming apparatus including the same.

What is claimed is:

1. A developing device, comprising:
a developing container that includes:
a plurality of conveyance chambers including a first conveyance chamber and a second conveyance chamber that are arranged mutually side by side;
a partition wall that divides the first conveyance chamber and the second conveyance chamber from each other along a longitudinal direction; and
a communication portion that establishes communication between the first conveyance chamber and the second conveyance chamber on both end sides of the partition wall,
the developing container containing a two-component developer including a carrier and a toner;
a first stirring conveyance member that conveys, while stirring, the developer present in the first conveyance chamber in a first direction;
a second stirring conveyance member that conveys, while stirring, the developer present in the second conveyance chamber in a second direction opposite to the first direction; and
a developer carrying member that is rotatably supported to the developing container and carries, on a surface thereof, the developer present in the second conveyance chamber,
wherein
the developing container includes:
a toner replenishment portion that directly feeds a replenishment toner into the developer present in the first conveyance chamber from an upstream side of the first conveyance chamber with respect to the first direction, and
the carrier satisfies Expression (1) below:
0.73≤FR×AD/shape factor≤2.10 (1)
where
FR denotes an amount of time [s/50 g] taken for 50 g of the carrier to be discharged,
AD denotes a bulk specific gravity [g/cm³] of the carrier, and
a shape factor refers to actually measured carrier volume average particle diameter/carrier particle diameter calculated from BET specific surface area.

2. The developing device according to claim 1, wherein
the toner replenishment portion includes:
a toner replenishment port; and
a toner replenishment path that extends horizontally on a lower side of the toner replenishment port and communicates with the first conveyance chamber from an upstream side with respect to the first direction, and
a rotary shaft of the first stirring conveyance member extends into the toner replenishment path, and on a part of the rotary shaft arranged in the toner replenishment path, a replenishment vane is formed that feeds a toner in the toner replenishment path into the first conveyance chamber along the rotary shaft.

3. The developing device according to claim 1, wherein
the carrier includes:
a carrier core that is a particle of a magnetic substance; and
a coat layer that is made of a resin and is formed on a surface of the carrier core, the coat layer containing carbon black as an electric conductor and barium titanate as a ferroelectric substance, and
when the carrier core is assumed to be truly spherical, the coat layer has an average weight per unit area of 0.2 to 2.7 [g/m²], and the barium titanate is added in an amount of 5 to 45 parts by mass with respect to 100 parts by mass of a coat resin forming the coat layer.

4. The developing device according to claim 3, wherein
the barium titanate is added in an amount of 25 to 45 parts by mass with respect to 100 parts by mass of the coat resin.

5. The developing device according to claim 3, wherein
the barium titanate has a. volume average particle diameter of not less than 100 nm and not more than 500 nm.

6. The developing device according to claim 3, wherein
the toner includes:
a toner base particle; and
a hydrophobic silica particle and a styrene-acrylate resin fine particle that are made to adhere to the toner base particle.

7. An image forming apparatus, comprising:
an image carrying member; and
the developing device according to claim 1 that makes the toner adhere to an electrostatic latent image formed on the image carrying member so as to form a toner image thereon.
